(19) United States
(12) Patent Application Publication
(10) Pub. No.: US 2025/0066196 A1
(43) Pub. Date: Feb. 27, 2025

(54) SULFURIC ACID RECOVERY DEVICE AND METHOD FOR RECOVERING SULFURIC ACID

(71) Applicant: Kioxia Corporation, Tokyo (JP)

(72) Inventor: Motonari TAKAHASHI, Yokkaichi (JP)

(73) Assignee: Kioxia Corporation, Tokyo (JP)

(21) Appl. No.: 18/794,139

(22) Filed: Aug. 5, 2024

(30) Foreign Application Priority Data
Aug. 22, 2023 (JP) 2023-134524
Aug. 25, 2023 (JP) 2023-137379

(51) Int. Cl. C01B 17/90; B01D 19/00

(52) U.S. Cl. CPC C01B 17/90; B01D 19/0078

(57) ABSTRACT

A sulfuric acid recovery device includes a first recovery tank configured to recover sulfuric acid; a concentration meter configured to measure a concentration of hydrogen peroxide in the sulfuric acid; a discharge pipe configured to discharge the sulfuric acid from the first recovery tank to a second recovery tank; a circulation pipe with a maximum installation height position equal to or lower than a maximum installation height position of the discharge pipe and with a flow path formed, causing the sulfuric acid to return to the first recovery tank; a first valve configured to open and close a flow path of the discharge pipe; a pump configured to feed the sulfuric acid discharged to at least the circulation pipe of the circulation pipe and the discharge pipe; and a control circuit configured to control opening and closing of the first valve in accordance with the concentration of the hydrogen peroxide.

### CROSS-REFERENCE TO RELATED APPLICATION(S)

This application is based upon and claims the benefit of priority from Japanese Patent Application No. 2023-134524, filed Aug. 22, 2023, and Japanese Patent Application No. 2023-137379, filed Aug. 25, 2023, the entire contents of which are incorporated herein by reference.

### FIELD

Embodiments described herein relate generally to a sulfuric acid recovery device and a method for recovering sulfuric acid.

### BACKGROUND

In a semiconductor manufacturing process, used sulfuric acid is discharged from a process chamber in a process using sulfuric acid. Therefore, a need to recover the used sulfuric acid occurs. The used sulfuric acid is collected in a recovery tank and then is conveyed. In the process using the sulfuric acid, hydrogen peroxide may be used in addition to sulfuric acid. The sulfuric acid recovered from the process chamber contains hydrogen peroxide.

In order to convey sulfuric acid by a tank lorry or the like, it is required that the hydrogen peroxide contained in the sulfuric acid is at lower than a predetermined concentration. On the other hand, as generation of a manufactured semiconductor device changes, a usage of the sulfuric acid and the hydrogen peroxide used in the process is increasing. Therefore, a concentration of the hydrogen peroxide in the recovered sulfuric acid tends to increase accordingly. As such, in order to convey the recovered sulfuric acid, it is desired to efficiently reduce the concentration of the hydrogen peroxide in the recovered sulfuric acid.

### DESCRIPTION OF THE DRAWINGS

FIG. 1 is a diagram showing an example of a configuration of a sulfuric acid recovery device in a first embodiment.

FIG. 2 is a diagram showing an example of a sulfuric acid recovery device in a comparative example of the first embodiment.

FIG. 3 is a diagram showing a method for reducing a concentration of hydrogen peroxide in sulfuric acid in the first embodiment.

FIG. 4 is a diagram showing an example of pipe diameters of a discharge pipe and a circulation pipe in the first embodiment.

FIG. 5 is a diagram showing a method for discharging sulfuric acid in the first embodiment.

### DETAILED DESCRIPTION

In general, according to one embodiment, a sulfuric acid recovery device includes a first recovery tank configured to recover sulfuric acid; a concentration meter configured to measure a concentration of hydrogen peroxide contained in the sulfuric acid in the first recovery tank;
a discharge pipe configured to discharge the sulfuric acid from the first recovery tank to a second recovery tank; a circulation pipe with a maximum installation height position set to be equal to or lower than a maximum installation height position of the discharge pipe and with a flow path formed, such that the sulfuric acid discharged from the first recovery tank returns to the first recovery tank; a first valve configured to open and close a flow path of the discharge pipe; a pump configured to feed the sulfuric acid discharged from the first recovery tank to at least the circulation pipe of the circulation pipe and the discharge pipe; and a control circuit configured to control opening and closing of the first valve in accordance with the concentration of the hydrogen peroxide measured by the concentration meter.

### First Embodiment

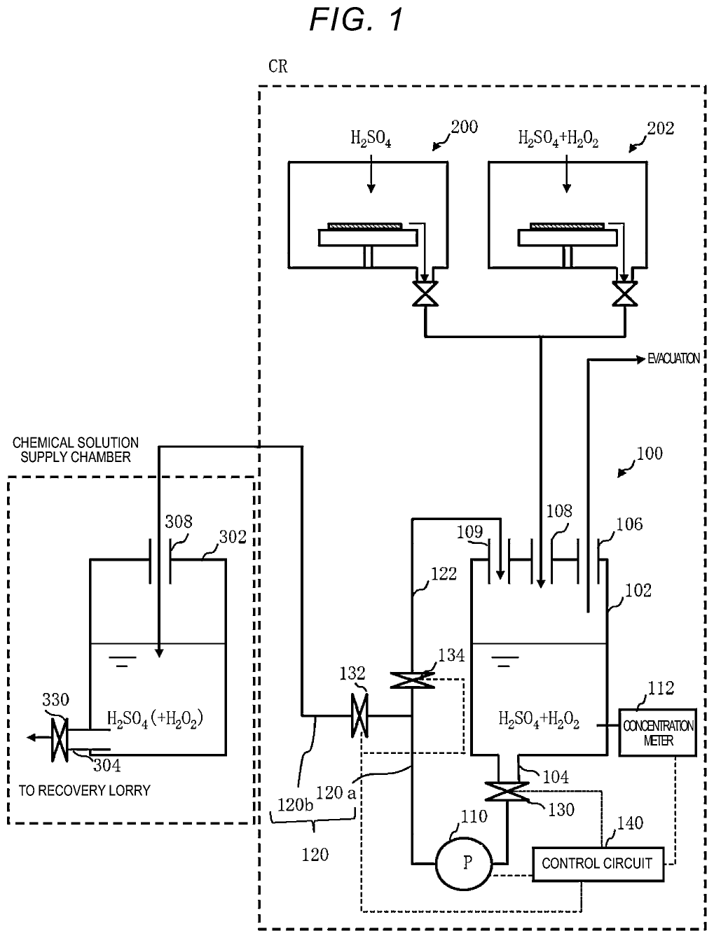

FIG. 1 is a diagram showing an example of a configuration of a sulfuric acid recovery device in a first embodiment. In FIG. 1, a sulfuric acid recovery device 100 includes a primary recovery tank 102 (first recovery tank), a pump 110, a concentration meter 112, a discharge pipe 120, a circulation pipe 122, valves 130, 132, and 134, and a control circuit 140.

The sulfuric acid recovery device 100 is disposed in, for example, a clean room CR.

For example, a plurality of process chambers 200 and 202 are disposed in the clean room CR, which is the same as or different from the sulfuric acid recovery device 100. In the example of FIG. 1, the process chamber 200 uses single sulfuric acid (H₂SO₄) for a process, and discharges the used sulfuric acid via a pipe. Further, in the process chamber 202, sulfuric acid containing hydrogen peroxide (H₂O₂) is used for the process, and the used sulfuric acid containing hydrogen peroxide is discharged via the pipe. The sulfuric acid recovery device 100 recovers the sulfuric acid discharged from the plurality of process chambers 200 and 202. In this way, the sulfuric acid recovery device 100 may recover both sulfuric acid containing hydrogen peroxide and sulfuric acid not containing hydrogen peroxide. The sulfuric acid recovery device 100 may recover only the sulfuric acid containing hydrogen peroxide.

The primary recovery tank 102 is formed of a material resistant to a chemical solution such as sulfuric acid. For example, a polytetrafluoroethylene (PTFE) lining tank or the like is used. The primary recovery tank 102 is formed of a discharge port 104, an evacuation port 106, a liquid suction port 108, and a liquid suction port 109. The discharge port 104 is disposed on a bottom surface of the primary recovery tank 102. The evacuation port 106, the liquid suction port 108, and the liquid suction port 109 are disposed on an upper surface of the primary recovery tank 102.

The example of FIG. 1 shows when the discharge port 104 is disposed on the bottom surface of the primary recovery tank 102, but the present disclosure is not limited thereto. The discharge port 104 may be disposed on a lower portion of a side surface of the primary recovery tank 102.

The sulfuric acid discharged from the plurality of process chambers 200 and 202 is recovered to the primary recovery tank 102 through the liquid suction port 108 located in an upper portion of the primary recovery tank 102. Therefore, the primary recovery tank 102 recovers the discharged sulfuric acid containing hydrogen peroxide. Accordingly, sulfuric acid containing hydrogen peroxide is stored in the primary recovery tank 102.

The evacuation port 106 is coupled to an external evacuation duct line. Hydrogen peroxide is an unstable substance as compared with sulfuric acid and is easily decomposed into water and oxygen (O₂), and the decomposed oxygen gas is released from the sulfuric acid to be evacuated to the external evacuation duct line through the evacuation port 106.

The discharge port 104 disposed on the lower portion of the primary recovery tank 102 is connected to a suction port of the pump 110 with the valve 130 interposed therebetween. In addition, a jet port of the pump 110 is connected to the discharge pipe 120.

The discharge pipe 120 is formed of the material resistant to the chemical solution such as sulfuric acid. For example, a PTFE lining pipe, a perfluoroalkoxyalkane (PFA) tube, or the like is used. In addition, the discharge pipe 120 is preferably configured to pass a pipe (tube) formed of the above-described material resistant to the chemical solution inside an outer pipe, using a vinyl chloride pipe as the outer pipe, for protection. The discharge pipe 120 discharges the sulfuric acid discharged from the primary recovery tank 102 to a secondary recovery tank 302 (second recovery tank). The secondary recovery tank 302 is disposed in, for example, a chemical solution supply chamber outside the clean room CR in which the sulfuric acid recovery device 100 is disposed. At that time, for example, the discharge pipe 120 extends toward an upper side once, then is bent horizontally, and then is connected to the secondary recovery tank 302 in the chemical solution supply chamber from the upper side. A flow path of the discharge pipe 120 is branched in a middle of the discharge pipe 120 extending toward the upper side, and one end of the circulation pipe 122 is connected to a branched point with the valve 134 interposed therebetween.

In addition, the valve 132 (first valve) is disposed in the vicinity of the branched point downstream of the branched discharge pipe 120. The valve 132 performs opening and closing of the flow path of the discharge pipe 120. Specifically, the valve 132 performs opening and closing of the flow path downstream of the discharge pipe 120 after branching from the circulation pipe 122. The example of FIG. 1 separately shows an upstream portion 120a of the discharge pipe 120, which is from the pump 110 to the branched point, and a downstream portion 120b of the discharge pipe 120 from the branched point.

The circulation pipe 122 is formed of the material resistant to the chemical solution such as sulfuric acid. For example, the PTFE lining pipe, the PFA tube, or the like is used. In addition, the circulation pipe 122 is preferably configured to pass the pipe (tube) formed of the above-described material resistant to the chemical solution inside an outer pipe, using a vinyl chloride pipe as the outer pipe, for protection. In the circulation pipe 122, a flow path is formed such that the sulfuric acid discharged from the primary recovery tank 102 returns to the primary recovery tank 102. In the example of FIG. 1, for example, the circulation pipe 122 extends toward the upper side from a branching position from the discharge pipe 120, then is bent horizontally, and then is connected to the primary recovery tank 102 from the upper side. Specifically, another end of the circulation pipe 122 is connected to the liquid suction port 109 disposed on the upper portion of the primary recovery tank 102. Then, a circulation line in which the sulfuric acid discharged returns from the primary recovery tank 102 to the primary recovery tank 102, is formed by the upstream portion 120a of the discharge pipe 120 and the circulation pipe 122. The valve 134 (second valve) performs opening and closing of a flow path of the circulation pipe 122. Alternatively, the valve 134 performs adjusting of an opening degree of the flow path of the circulation pipe 122.

In the example of FIG. 1, the upstream portion 120a of the discharge pipe 120 is used up to the vicinity of an intermediate height position of the discharge pipe 120, in common with a line of the discharge pipe 120 and the circulation line, but the present disclosure is not limited thereto. It is also preferable that the upstream portion 120a is branched from the jet port of the pump 110, so that the discharge pipe 120 and the circulation pipe 122 are separately provided, without commonalizing the upstream portion 120a of the discharge pipe 120.

A centrifugal pump such as a magnet pump is used for the pump 110. For example, the pump 110 uses an impeller-type chemical solution pump resistant to sulfuric acid. The pump 110 feeds the sulfuric acid containing hydrogen peroxide discharged from the primary recovery tank 102 to at least one of the circulation pipe 122 and the discharge pipe 120.

When the discharge pipe 120 and the circulation pipe 122 are separately provided by branching in the vicinity of the pump 110 without commonalizing the upstream portion 120a of the discharge pipe 120, the pump 110 may also be disposed to be separated into a pump for the discharge pipe 120 and a pump for the circulation pipe 122. When the pump for the discharge pipe 120 and the pump for the circulation pipe 122 are separated, the pump for the circulation pipe 122 feeds the sulfuric acid containing hydrogen peroxide discharged from the primary recovery tank 102 to at least the circulation pipe 122 of the circulation pipe 122 and the discharge pipe 120. The pump for the discharge pipe 120 feeds the sulfuric acid containing hydrogen peroxide discharged from the primary recovery tank 102 to at least the discharge pipe 120 of the circulation pipe 122 and the discharge pipe 120.

An output of the concentration meter 112 is connected to the control circuit 140. In addition, an ON/OFF operation of the pump 110 and an opening and closing operation of the valves 130, 132, and 134 are controlled by, for example, the control circuit 140. The example of FIG. 1 shows a wiring among the concentration meter 112, the pump 110, the valves 130, 132, and 134, and the control circuit 140, which is indicated by a dotted line. However, the present disclosure is not limited thereto. The ON/OFF operation of the pump 110 and the opening and closing operation of the valves 130, 132, and 134 may be manually performed.

The sulfuric acid supplied to the pump 110 is fed to the discharge pipe 120 by the pump 110 to be recovered to the secondary recovery tank 302 connected to the jet port of the discharge pipe 120. Specifically, the jet port of the discharge pipe 120 is connected to a liquid suction port 308 of the secondary recovery tank 302. The sulfuric acid recovered to the secondary recovery tank 302 is loaded onto a tank lorry via a valve 330 from a discharge port 304 in a lower portion of the secondary recovery tank 302 to be conveyed, and then is discarded or sold as valuable. A pump for feeding sulfuric acid to the tank lorry is connected downstream of the valve 330, but the involved pump is not shown.

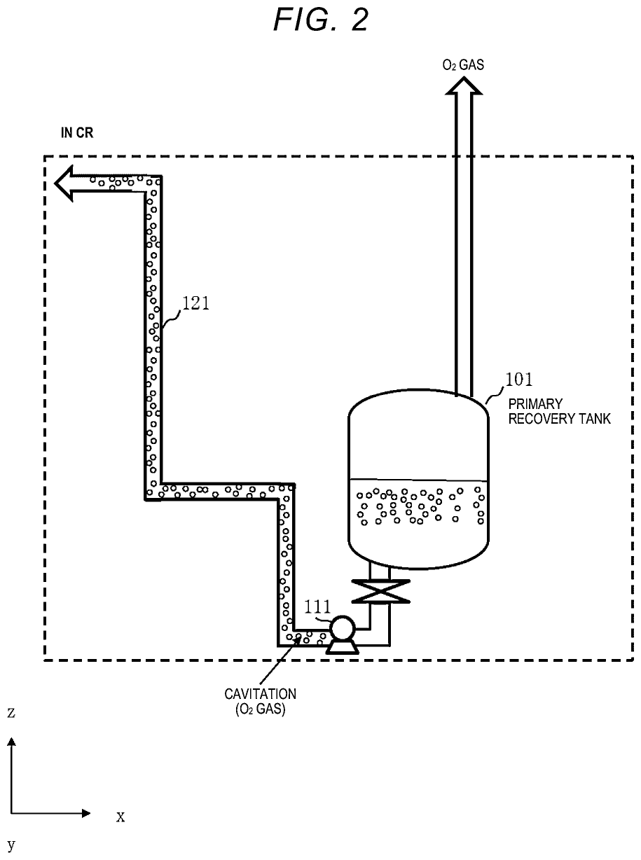

FIG. 2 is a diagram showing an example of a sulfuric acid recovery device in a comparative example of the first embodiment. The example of FIG. 2 does not show a pipe and a liquid suction port in which the sulfuric acid containing hydrogen peroxide discharged from the process chamber enters a primary recovery tank 101. In the example of FIG. 2, a horizontal direction is set as x and y directions, and a height direction is indicated by a z direction. The comparative example shows a configuration in which the circulation line is not disposed. The sulfuric acid containing hydrogen peroxide is stored in the primary recovery tank 101. The sulfuric acid recovered to the primary recovery tank 101 is fed to an external secondary recovery tank (not shown) by a pump 111, via a discharge pipe 121.

As described above, as generation of a manufactured semiconductor device changes, a usage of the sulfuric acid and the hydrogen peroxide used in the process is increasing. Therefore, the concentration of the hydrogen peroxide in the sulfuric acid recovered to the primary recovery tank 101 also tends to increase. Therefore, it takes time for the concentration of the hydrogen peroxide in the primary recovery tank 101 to naturally be reduced. Further, in the involved aspect, the concentration of the hydrogen peroxide remains high even when the hydrogen peroxide is fed to the secondary recovery tank, so that it is difficult not only to sell the sulfuric acid as valuable, but also to convey the sulfuric acid by the tank lorry. Therefore, it is desired to efficiently reduce the concentration of the hydrogen peroxide.

Meanwhile, since hydrogen peroxide is an unstable substance as compared with sulfuric acid, cavitation is generated when the pump 111 is operated in the involved aspect. Specifically, by a rotation of a rotor (impeller) of the centrifugal pump, a pressure on a suction side of the pump 111 is relatively reduced, the hydrogen peroxide in the sulfuric acid is decomposed, and oxygen appears as bubbles. In the first embodiment, the concentration of the hydrogen peroxide in the sulfuric acid is efficiently reduced by using the involved phenomenon.

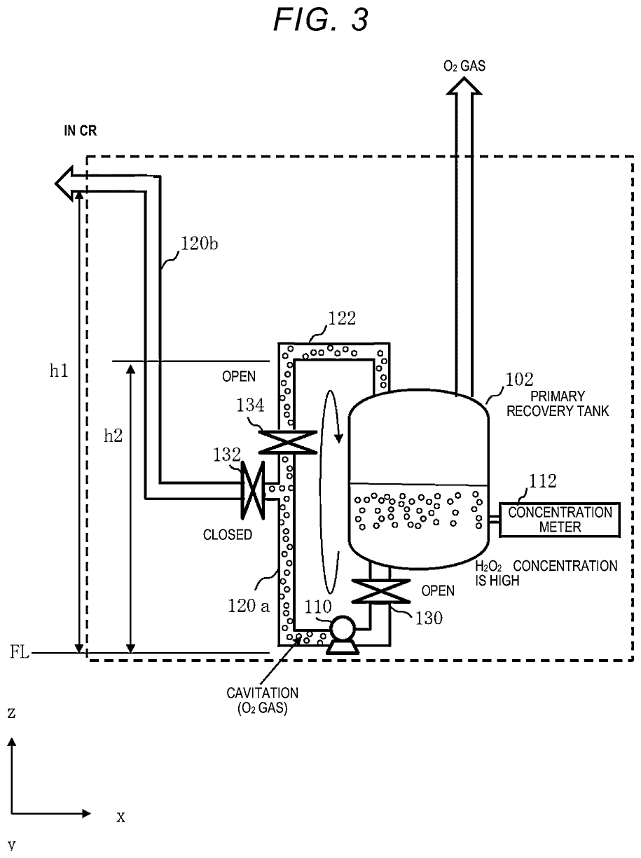

FIG. 3 is a diagram showing a method for reducing the concentration of the hydrogen peroxide in the sulfuric acid in the first embodiment. The example of FIG. 3 does not show a pipe and a liquid suction port in which the sulfuric acid containing hydrogen peroxide discharged from the process chamber enters the primary recovery tank 102. In addition, the example of FIG. 3 does not show a configuration in the chemical solution supply chamber and the control circuit 140. In the example of FIG. 3, a horizontal direction is set as x and y directions, and a height direction is indicated by a z direction. In the first embodiment, the concentration meter 112 measures (monitors) the concentration of the hydrogen peroxide in the sulfuric acid stored in the primary recovery tank 102. The measurement may be performed at all times or at a predetermined sampling interval. For example, it is preferable that the measurement is performed every several seconds or several minutes.

In the first embodiment, for example, unless a concentration of hydrogen peroxide in the secondary recovery tank 302 is lower than 5 wt %, the sulfuric acid may not be loaded onto the tank lorry, so that the sulfuric acid may not be conveyed. Furthermore, for example, when the concentration of the hydrogen peroxide in the secondary recovery tank 302 is not lower than 1 wt %, the recovered sulfuric acid cannot be sold as valuable. Therefore, when the concentration of the hydrogen peroxide measured by the concentration meter 112 is higher than a preset value, the control circuit 140 operates the pump 110 in a state where the valve 132 is closed and the valves 130 and 134 are open. Then, the sulfuric acid containing hydrogen peroxide recovered to the primary recovery tank 102 is circulated between the circulation pipe 122 and the primary recovery tank 102. As a result, cavitation is generated, the decomposition of hydrogen peroxide is accelerated, and more oxygen bubbles are generated.

In the first embodiment, as shown in FIG. 3, for example, the discharge pipe 120 is pulled to the secondary recovery tank 302 in the chemical solution supply chamber shown in FIG. 1, through a position where a maximum installation height position is at a height h1 from a height position of a floor of the clean room CR. The discharge pipe 120 is branched at a height position in a middle of height lower than the height h1, and the one end of the circulation pipe 122 is connected to the branched point with the valve 134 interposed therebetween. The circulation pipe 122 forms a maximum installation height position equal to or lower than the maximum installation height position of the discharge pipe 120. More preferably, as shown in FIG. 3, in the circulation pipe 122, a maximum installation height position may be set at a height h2 lower than the height h1, which is the maximum installation height position of the discharge pipe 120. The example in FIG. 3 shows, for example, when the maximum installation height position is defined as a height position of a bottom portion of a pipe extending horizontally at an uppermost side.

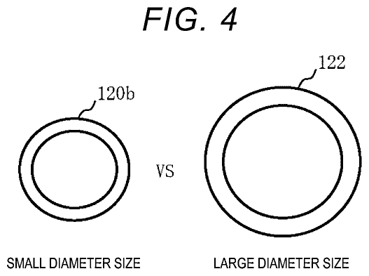

FIG. 4 is a diagram showing an example of pipe diameters of the discharge pipe and the circulation pipe in the first embodiment. A pipe diameter of the circulation pipe 122 is formed with a size equal to or larger than a pipe diameter of the discharge pipe 120. A standard size of a pipe is generally defined along an outer diameter size, but it is general that an inner diameter size also increases when an outer shape size is large. Here, it suffices that an inner diameter size of the circulation pipe 122 may simply be equal to or larger than an inner diameter size of the discharge pipe 120. As a result, a pipe resistance of the circulation pipe 122 may be made equal to or less than a pipe resistance of the discharge pipe 120. More preferably, as shown in FIG. 4, the pipe diameter of the circulation pipe 122 may be formed with a size larger than the pipe diameter of the discharge pipe 120. As a result, the pipe resistance of the circulation pipe 122 may be made smaller than the pipe resistance of the discharge pipe 120.

Therefore, when the pump 110 has a lifting performance of pushing up sulfuric acid to the height h1, which is the maximum installation height position of the discharge pipe 120, in a state where cavitation is generated, the sulfuric acid can be circulated via the circulation pipe 122 in which the maximum installation height position is at the height h2 equal to or lower than the height h1, in a state where cavitation is generated.

Since bubbles of the oxygen gas generated by cavitation are contained in the circulated sulfuric acid, the oxygen gas is released from the sulfuric acid at a stage of returning to the primary recovery tank 102 to be evacuated to the external evacuation duct line through the evacuation port 106. By repeating the circulation of the sulfuric acid, the concentration of the hydrogen peroxide contained in the sulfuric acid can be efficiently reduced.

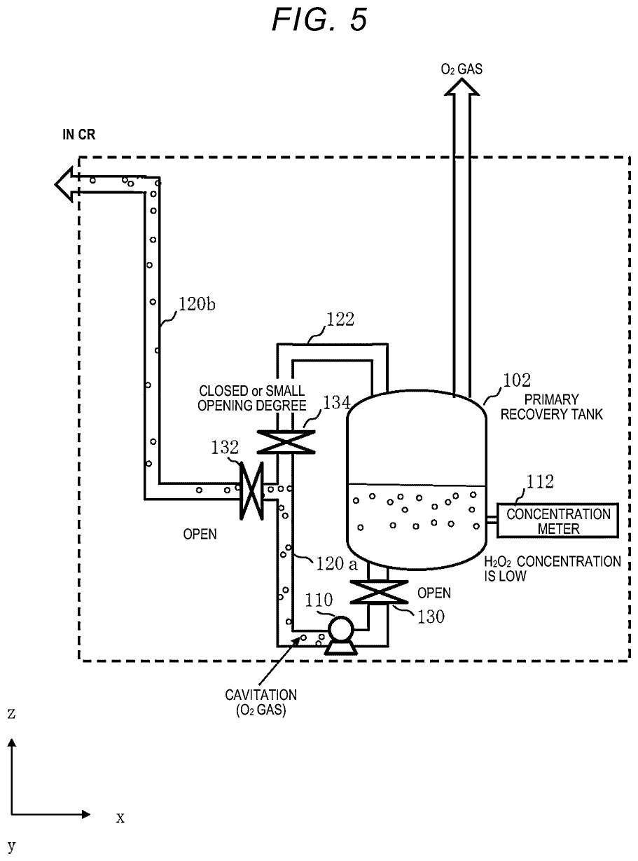

FIG. 5 is a diagram showing a method for discharging the sulfuric acid in the first embodiment. The example of FIG. 5 does not show a drawing of the liquid suction port in which the sulfuric acid, where the hydrogen peroxide discharged from the process chamber is contained, enters the primary recovery tank 102 and does not show a drawing of the control circuit 140. In addition, the example of FIG. 5 does not show the configuration in the chemical solution supply chamber. In the example of FIG. 5, a horizontal direction is set as x and y directions, and a height direction is indicated by a z direction.

The control circuit 140 controls opening and closing of the valve 132 in accordance with the concentration of the hydrogen peroxide measured by the concentration meter 112. Similarly, the control circuit 140 controls opening and closing or an opening degree of the valve 134 in accordance with the concentration of the hydrogen peroxide measured by the concentration meter 112. Specifically, it operates as follows.

When the concentration of the hydrogen peroxide measured by the concentration meter 112 is equal to or lower than a predetermined value, the sulfuric acid circulating through the circulation pipe 122 and the primary recovery tank 102 is discharged to the secondary recovery tank 302 via the downstream portion 120b of the discharge pipe 120. Therefore, the control circuit 140 controls the valve 132 to be in an open state from a closed state, when the concentration of the hydrogen peroxide measured by the concentration meter 112 is equal to or lower than the predetermined value from a state where the concentration is higher than the predetermined value. Similarly, the control circuit 140 controls the valve 134 to close from open or to reduce the opening degree, when the concentration of the hydrogen peroxide measured by the concentration meter 112 is equal to or lower than the predetermined value. By not completely closing the valve 134, a shut-off operation of the pump 110 may be set to not occur.

As a result, the sulfuric acid, in which the concentration of hydrogen peroxide is equal to or lower than the predetermined value, can be discharged to the secondary recovery tank 302 via the downstream portion 120b of the discharge pipe 120. In a state of the example in FIG. 5, since the concentration of the hydrogen peroxide is low, an amount of bubbles can be reduced even when cavitation is generated in the pump 110. Therefore, a deterioration of the performance of the pump 110 can be reduced or minimized, so that the sulfuric acid can be efficiently discharged.

When the discharged sulfuric acid is sold as valuable, the predetermined value of the concentration of the hydrogen peroxide here can be set to, for example, a value equal to or lower than 1 wt %. Meanwhile, when the bubbles of the oxygen gas are further generated by cavitation while the sulfuric acid moves into the discharge pipe 120, the bubbles may be released from the sulfuric acid even in the secondary recovery tank 302. In view of this, the predetermined value may be set to a value of 1 wt %+α. It is preferable to set α to be lower than 1 wt %, for example, about 0.1 to 0.5 wt %.

On the other hand, when the sulfuric acid cannot be sold as valuable but may simply be conveyed by the tank lorry, it is desirable to set the concentration of the hydrogen peroxide to a value equal to or lower than 5 wt %, as the predetermined value. Therefore, at least, the valve 132 is opened when the concentration of the hydrogen peroxide measured by the concentration meter 112 is equal to or lower than 5 wt %.

As described above, in the sulfuric acid recovered to the secondary recovery tank 302, the concentration of the hydrogen peroxide is at least lower than 5 wt %, so that the sulfuric acid is loaded onto the tank lorry to be conveyed. Furthermore, when the concentration of the hydrogen peroxide is lower than 1 wt %, the conveyed sulfuric acid can be sold as valuable.

As described above, according to the first embodiment, the concentration of the hydrogen peroxide in the recovered sulfuric acid can be efficiently reduced to be discharged.

As described above, embodiments are described with reference to specific examples. However, the present disclosure is not limited to the specific examples.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A sulfuric acid recovery device comprising:
a first recovery tank configured to recover sulfuric acid;
a concentration meter configured to measure a concentration of hydrogen peroxide contained in the sulfuric acid in the first recovery tank;
a discharge pipe configured to discharge the sulfuric acid from the first recovery tank to a second recovery tank;
a circulation pipe with a maximum installation height position set to be equal to or lower than a maximum installation height position of the discharge pipe and with a flow path formed, such that the sulfuric acid discharged from the first recovery tank returns to the first recovery tank;
a first valve configured to open and close a flow path of the discharge pipe;
a pump configured to feed the sulfuric acid discharged from the first recovery tank to at least the circulation pipe of the circulation pipe and the discharge pipe; and
a control circuit configured to control opening and closing of the first valve in accordance with the concentration of the hydrogen peroxide measured by the concentration meter.

2. The sulfuric acid recovery device according to claim 1, wherein
a pipe diameter of the circulation pipe is equal to or larger than a pipe diameter of the discharge pipe.

3. The sulfuric acid recovery device according to claim 1, wherein
the pump includes a centrifugal pump.

4. The sulfuric acid recovery device according to claim 3, wherein
the pump includes a magnet pump.

5. The sulfuric acid recovery device according to claim 1, wherein
the circulation pipe branches in a middle of the discharge pipe, extends toward an upper side from a branching position from the discharge pipe, bends horizontally, and is connected to the first recovery tank from the upper side.

6. The sulfuric acid recovery device according to claim 5, wherein
the pump is provided upstream from the branching position of the circulation pipe in the discharge pipe.

7. The sulfuric acid recovery device according to claim 5, wherein
the first valve is provided downstream from the branching position of the circulation pipe in the discharge pipe.

8. The sulfuric acid recovery device according to claim 1, wherein
the control circuit is configured to control the first valve to be in an open state when the concentration of the hydrogen peroxide measured by the concentration meter is equal to or lower than 5 wt %.

9. The sulfuric acid recovery device according to claim 1, wherein
the control circuit is configured to control the first valve to be in an open state from a closed state when the concentration of the hydrogen peroxide measured by the concentration meter is equal to or lower than a predetermined value from a state where the concentration is higher than the predetermined value.

10. The sulfuric acid recovery device according to claim 9, further comprising:
a second valve provided in the circulation pipe, wherein
the control circuit is further configured to control the second valve to be in a closed state from an open state or to reduce an opening degree when the concentration of the hydrogen peroxide measured by the concentration meter is equal to or lower than the predetermined value from the state where the concentration is higher than the predetermined value.

11. The sulfuric acid recovery device according to claim 1, further comprising:
an evacuation port provided in the first recovery tank and configured to discharge oxygen gas generated by decomposition of the hydrogen peroxide.

12. The sulfuric acid recovery device according to claim 11, wherein
the evacuation port is coupled to an external evacuation duct line.

13. The sulfuric acid recovery device according to claim 1, wherein
the first recovery tank is to be coupled to a first process chamber and a second process chamber, and
single sulfuric acid is discharged from the first process chamber to the first recovery tank, and sulfuric acid containing hydrogen peroxide is discharged from the second process chamber to the first recovery tank.

14. A method for recovering sulfuric acid, comprising:
discharging sulfuric acid to a first recovery tank from both a first process chamber using the sulfuric acid and a second process chamber using the sulfuric acid and hydrogen peroxide;
measuring a concentration of the hydrogen peroxide contained in the sulfuric acid discharged from both the first and second process chambers and stored in the first recovery tank;
circulating the sulfuric acid in the first recovery tank between a circulation pipe and the first recovery tank; and
discharging the sulfuric acid circulating through the circulation pipe and the first recovery tank to a second recovery tank via a discharge pipe when the measured concentration of the hydrogen peroxide is equal to or lower than a predetermined value.

15. The method for recovering sulfuric acid according to claim 14, wherein
cavitation is generated in the circulation pipe to decompose the hydrogen peroxide contained in the sulfuric acid, so that bubbles of oxygen gas are generated when the sulfuric acid is circulated.

16. The method for recovering sulfuric acid according to claim 15, wherein
the oxygen gas is discharged to an external evacuation duct line via an evacuation port provided in the first recovery tank.

17. The method for recovering sulfuric acid according to claim 14, wherein
the first recovery tank, the circulation pipe, and a part of the discharge pipe are disposed in a clean room, and the second recovery tank is disposed outside the clean room.

18. The method for recovering sulfuric acid according to claim 14, wherein
the sulfuric acid is discharged to the second recovery tank via the discharge pipe when the measured concentration of the hydrogen peroxide is equal to or lower than 5 wt %.

19. The method for recovering sulfuric acid according to claim 14, wherein
the concentration of the hydrogen peroxide contained in the sulfuric acid is controlled to be lower than 5 wt % in the second recovery tank.

20. The method for recovering sulfuric acid according to claim 14, wherein
the concentration of the hydrogen peroxide contained in the sulfuric acid is controlled to be lower than 1 wt % in the second recovery tank.
